(19) United States
(12) Patent Application Publication
(10) Pub. No.: US 2026/0214661 A1
(43) Pub. Date: Jul. 23, 2026

(54) USER EQUIPMENT INITIATED BEAM MANAGEMENT REQUESTS ASSOCIATED WITH MULTIPLE TRANSMISSION RECEPTION POINTS

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/157,876

(22) PCT Filed: Apr. 17, 2023
(86) PCT No.: PCT/CN2023/088585

§ 371 Date: Aug. 19, 2025

(51) Int. Cl. H04W 72/044; H04L 1/1829; H04W 72/21

(52) U.S. Cl. CPC H04W 72/046; H04L 1/1854; H04W 72/21

(57) ABSTRACT

Various aspects of the present disclosure generally relate to wireless communication. In some aspects, a user equipment (UE) may transmit a beam management request communication comprising a plurality of beam management requests, each beam management request of the plurality of beam management requests corresponding to a respective transmission reception point (TRP) of a plurality of TRPs. The UE may perform, based on the beam management request communication, a beam management operation associated with at least one TRP of the plurality of TRPs. Numerous other aspects are described.

### FIELD OF THE DISCLOSURE

Aspects of the present disclosure generally relate to wireless communication and to techniques and apparatuses for user equipment initiated beam management requests associated with multiple transmission reception points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include a memory and one or more processors coupled to the memory. The one or more processors may be configured to transmit a beam management request communication comprising a plurality of beam management requests, each beam management request of the plurality of beam management requests corresponding to a respective transmission reception point (TRP) of a plurality of TRPs. The one or more processors may be configured to perform, based on the beam management request communication, a beam management operation associated with at least one TRP of the plurality of TRPs.

Some aspects described herein relate to an apparatus for wireless communication at a network node. The apparatus may include a memory and one or more processors coupled to the memory. The one or more processors may be configured to receive a beam management request communication comprising a plurality of beam management requests, each beam management request of the plurality of beam management requests corresponding to a respective TRP of a plurality of TRPs. The one or more processors may be configured to perform, based on the beam management request communication, a beam management operation associated with at least one TRP of the plurality of TRPs.

Some aspects described herein relate to a method of wireless communication performed by a UE. The method may include transmitting a beam management request communication comprising a plurality of beam management requests, each beam management request of the plurality of beam management requests corresponding to a respective TRP of a plurality of TRPs. The method may include performing, based on the beam management request communication, a beam management operation associated with at least one TRP of the plurality of TRPs.

Some aspects described herein relate to a method of wireless communication performed by a network node. The method may include receiving a beam management request communication comprising a plurality of beam management requests, each beam management request of the plurality of beam management requests corresponding to a respective TRP of a plurality of TRPs. The method may include performing, based on the beam management request communication, a beam management operation associated with at least one TRP of the plurality of TRPs.

Some aspects described herein relate to a non-transitory computer-readable medium that stores a set of instructions for wireless communication by a UE. The set of instructions, when executed by one or more processors of the UE, may cause the UE to transmit a beam management request communication comprising a plurality of beam management requests, each beam management request of the plurality of beam management requests corresponding to a respective TRP of a plurality of TRPs. The set of instructions, when executed by one or more processors of the UE, may cause the UE to perform, based on the beam management request communication, a beam management operation associated with at least one TRP of the plurality of TRPs.

Some aspects described herein relate to a non-transitory computer-readable medium that stores a set of instructions for wireless communication by a network node. The set of instructions, when executed by one or more processors of the network node, may cause the network node to receive a beam management request communication comprising a plurality of beam management requests, each beam management request of the plurality of beam management requests corresponding to a respective TRP of a plurality of TRPs. The set of instructions, when executed by one or more processors of the network node, may cause the network node to perform, based on the beam management request communication, a beam management operation associated with at least one TRP of the plurality of TRPs.

Some aspects described herein relate to an apparatus for wireless communication. The apparatus may include means for transmitting a beam management request communication comprising a plurality of beam management requests, each beam management request of the plurality of beam management requests corresponding to a respective TRP of a plurality of TRPs. The apparatus may include means for performing, based on the beam management request communication, a beam management operation associated with at least one TRP of the plurality of TRPs.

Some aspects described herein relate to an apparatus for wireless communication. The apparatus may include means for receiving a beam management request communication comprising a plurality of beam management requests, each beam management request of the plurality of beam management requests corresponding to a respective TRP of a plurality of TRPs. The apparatus may include means for performing, based on the beam management request communication, a beam management operation associated with at least one TRP of the plurality of TRPs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of multiple transmission reception point (mTRP) communication, in accordance with the present disclosure.

FIG. 5 is a diagram illustrating an example associated with UE initiated beam management requests associated with multiple transmission reception points (TRPs), in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

A network node can transmit many beams to a user equipment (UE). In some aspects, the UE can select a set of beams for communication with the network node. For example, the UE can select the set of beams based at least in part on the set of beams being associated with favorable characteristics. The UE can generate a codeword that indicates the set of beams and parameters to be used for using a codebook based at least in part on performing channel estimation of the channel between the network node and the UE. A UE can communicate with a number of transmission reception points (TRPs) using beams.

Once a network node and a UE have selected beams for one or more beam pairs, the network node may be aware of one or more UE beams used by the UE.

However, the UE may autonomously switch a receive beam (e.g., a UE beam of a beam pair) based at least in part on changed reception conditions. If the UE autonomously switches a receive beam (e.g., based at least in part on mobility of the UE, rotation of the UE, and/or the like), the network node may be unaware that the UE has switched receive beams until a subsequent channel state feedback (CSF) report and/or a subsequent beam report. Based at least in part on the network node being unaware that the UE has switched receive beams, the network node may use outdated channel state information (CSI), which may degrade performance of a communication link between the network node and the UE. For example, based at least in part on the network node using outdated CSI, the UE may receive downlink communications with an increased error rate and/or with suboptimal spectral efficiency, among other examples, which may consume communication and network resources.

In some aspects described herein, a UE may determine a change of one or more reception conditions and may transmit (e.g., autonomously) a beam management request communication including a plurality of beam management requests, each of which correspond to a TRP of a plurality of TRPs, for a beam management operation to update at least one beam associated with at least one TRP of a plurality of TRPs in communications with the UE. In some aspects, a change of one or more reception conditions may include, or may be based at least in part on, the UE changing a UE transmission beam and/or a UE reception beam, a link quality change (e.g., a change in reference signal received power (RSRP), signal to interference plus noise ratio (SINR), pathloss, and/or the like), movement of the UE, a speed change of the UE, an orientation change of the UE, detected reflector and/or scatter changes (e.g., angle and/or strength changes of received signals), and/or the like.

In some aspects, the UE may transmit the beam management request communication via one or more MAC CEs and/or via uplink control information (UCI). In some aspects, the UE may use an existing grant to transmit the beam management request communication, request a new grant to transmit the beam management request communication, and/or transmit the beam management request communication with other UCI (e.g., hybrid automatic repeat request (HARQ) feedback).

Based at least in part on receiving the request for the radio link adaptation operation, the network node (which may be, include, or be included in, one or more TRPs of the plurality of TRPs) may schedule the UE to receive one or more reference signals and/or report measurements and/or metrics associated with the one or more reference signals. This may facilitate beam synchronization between the TRPs and the UE and may allow the TRPs to receive current CSI to determine downlink transmission parameters. Based at least in part on the TRPs receiving current CSI to determine downlink transmission parameters, the TRPs (e.g., via the network node) may determine proper transmission parameters (e.g., a modulation and coding schemes (MCS), a transport block size, a resource allocation, a transmit power, a beam direction, and/or the like) for downlink communications, which may conserve communication, network, and/or power resources associated with the UE and/or the TRPs.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

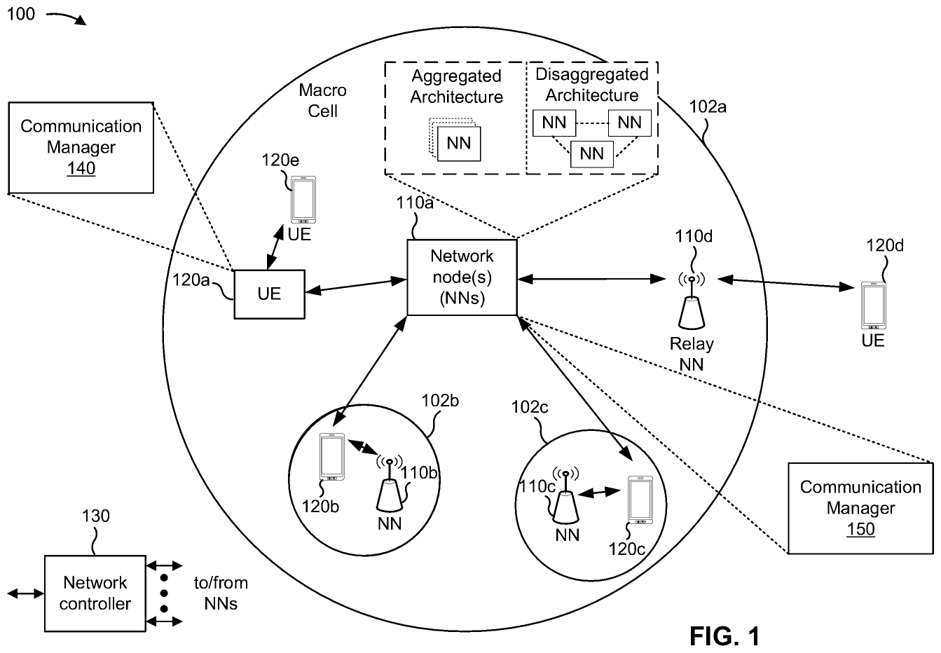

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may transmit a beam management request communication comprising a plurality of beam management requests, each beam management request of the plurality of beam management requests corresponding to a respective TRP of a plurality of TRPs; and perform, based on the beam management request communication, a beam management operation associated with at least one TRP of the plurality of TRPs. Additionally, or alternatively, the communication manager 140 may perform one or more other operations described herein.

In some aspects, a network node (e.g., the network node 110) may include a communication manager 150. As described in more detail elsewhere herein, the communication manager 150 may receive a beam management request communication comprising a plurality of beam management requests, each beam management request of the plurality of beam management requests corresponding to a respective TRP of a plurality of TRPs; and perform, based on the beam management request communication, a beam management operation associated with at least one TRP of the plurality of TRPs. Additionally, or alternatively, the communication manager 150 may perform one or more other operations described herein.

As indicated above, FIG. 1 is provided as an example. Other examples may differ from what is described with regard to FIG. 1.

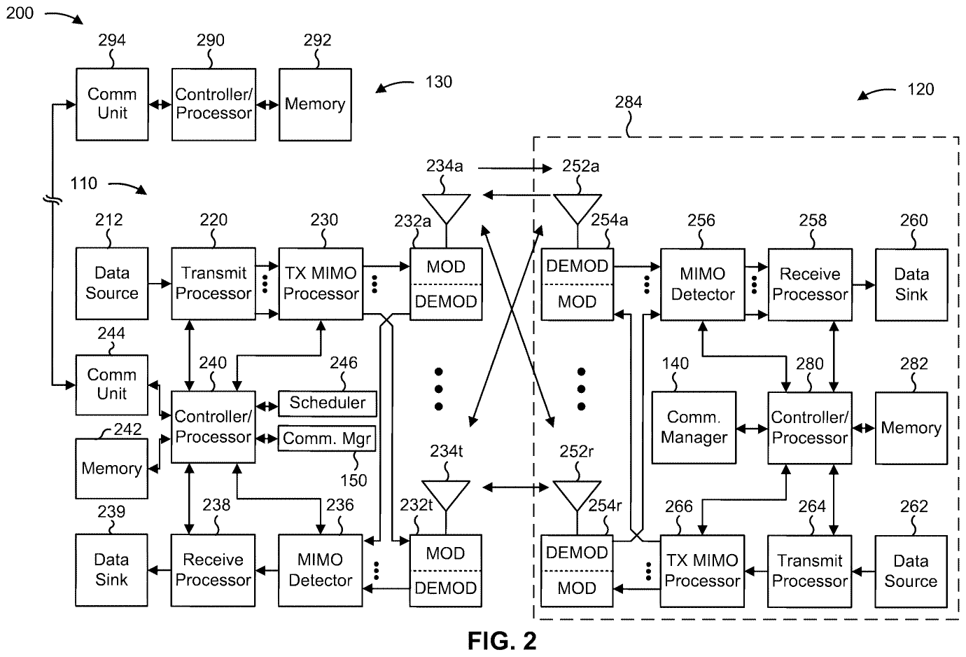

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more MCSs for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-Resourceld, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

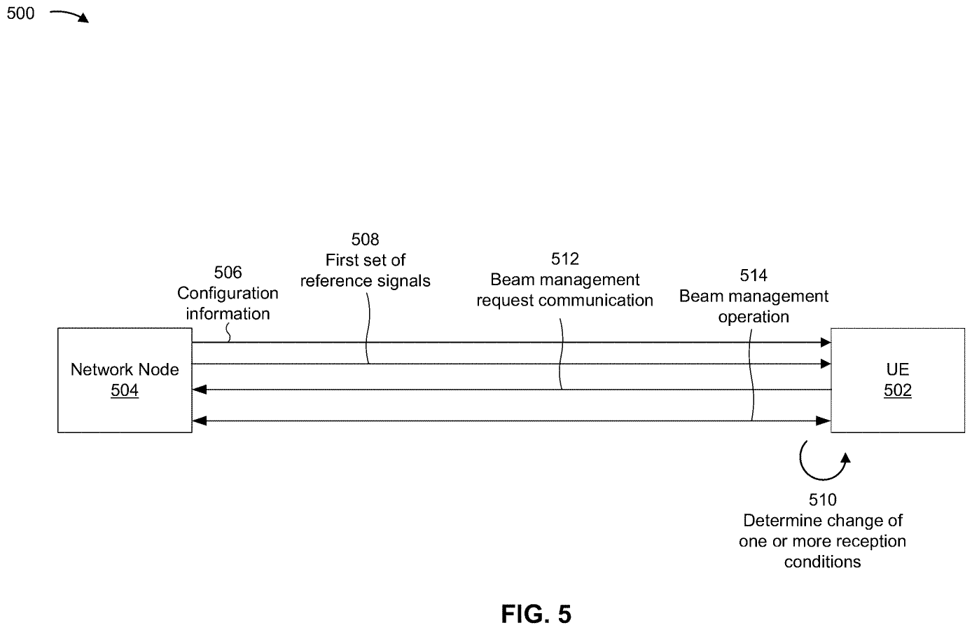

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

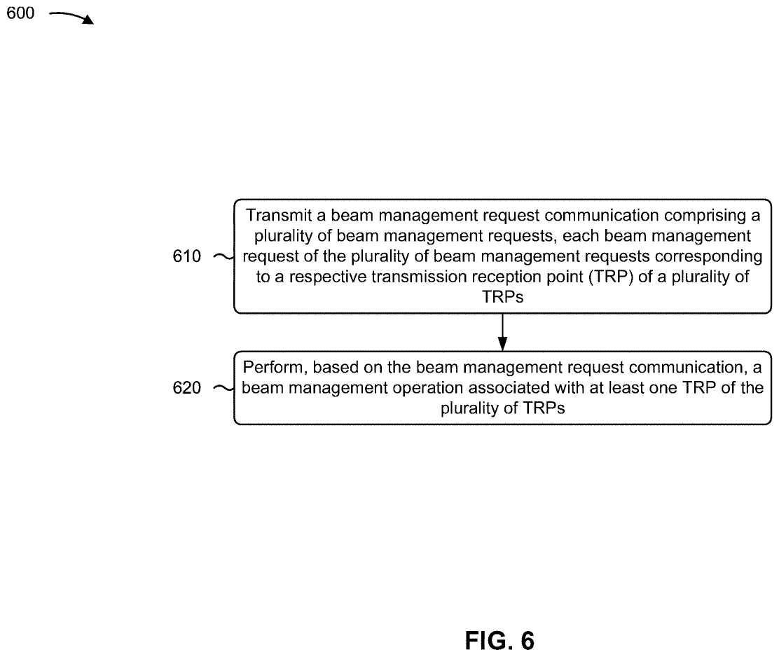

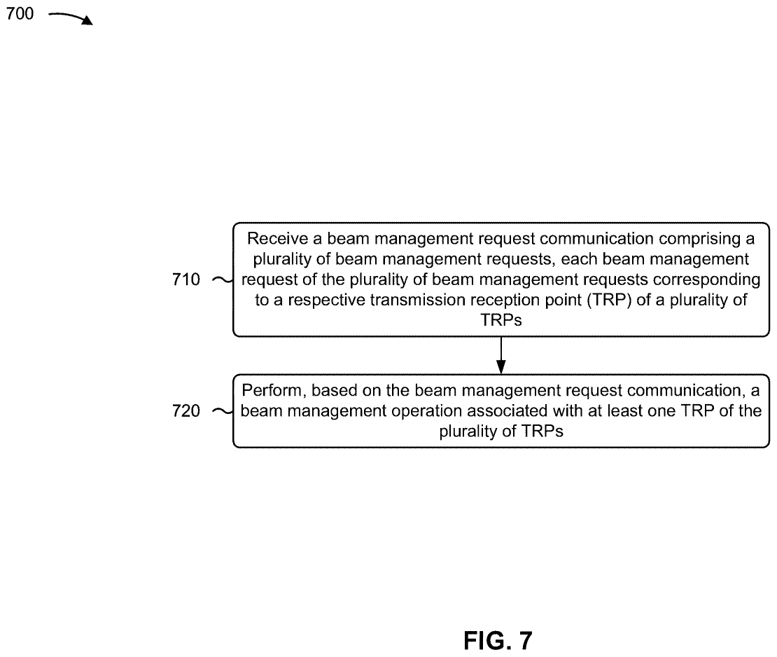

The controller/processor 240 of the network node 110, the controller/processor 280 of the UE 120, and/or any other component(s) of FIG. 2 may perform one or more techniques associated with UE initiated beam management requests associated with multiple TRPs, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting a beam management request communication comprising a plurality of beam management requests, each beam management request of the plurality of beam management requests corresponding to a respective TRP of a plurality of TRPs; and/or means for performing, based on the beam management request communication, a beam management operation associated with at least one TRP of the plurality of TRPs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving a beam management request communication comprising a plurality of beam management requests, each beam management request of the plurality of beam management requests corresponding to a respective TRP of a plurality of TRPs; and/or means for performing, based on the beam management request communication, a beam management operation associated with at least one TRP of the plurality of TRPs. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

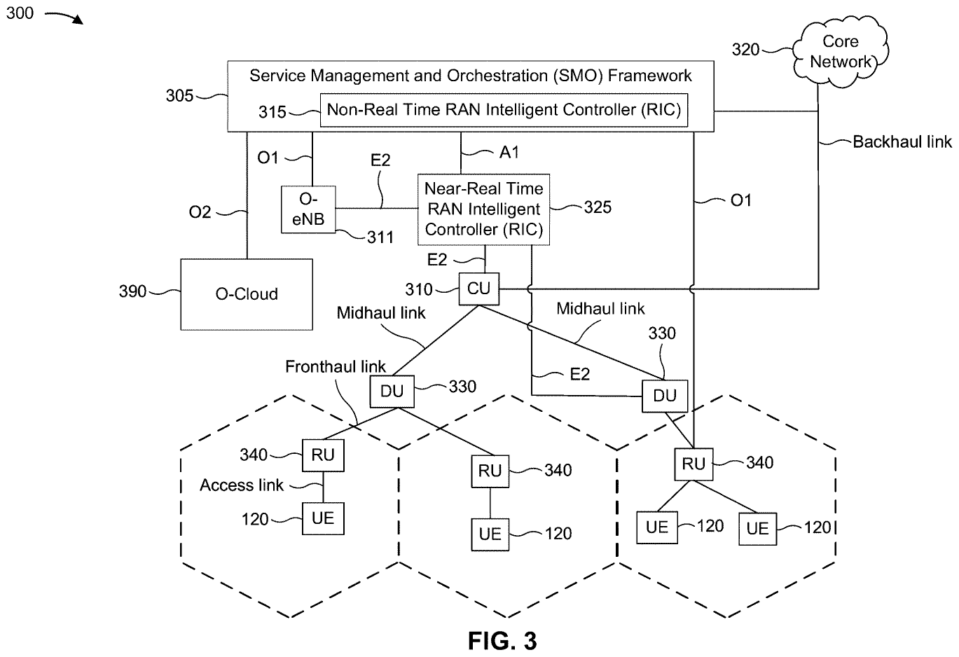

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A network node (e.g., network node 110) can transmit many beams to a UE (e.g., UE 120). “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal. For example, the network node can generate the beams using an antenna panel that generates beams at a spatial and/or phase displacement from each other. The network node and the UE can select a set of beams that are to be used for communication between the network node and the UE. For example, the set of beams transmitted from the network node to the UE can be referred to herein as a communication link, a downlink, and/or the like. The communication link between the network node and the UE can propagate in a medium and/or through various geometric paths, which are collectively referred to herein as a channel between the network node and the UE.

In some aspects, the UE can select a set of beams for communication with the network node. For example, the UE can select the set of beams based at least in part on the set of beams being associated with favorable characteristics (e.g., a satisfactory receive power, a satisfactory SINR value, etc.). The UE can generate a codeword that indicates the set of beams and parameters to be used for using a codebook based at least in part on performing channel estimation of the channel between the network node and the UE. In some aspects, the codebook may be HARQ codebook.

One such codebook is the type-II codebook, prescribed in 5G/NR. The type-II codebook can use a two-stage procedure to generate the codeword: a first stage wherein the set of beams is selected for a wideband of the communication link (e.g., sometimes referred to herein as W1), and a second stage wherein linear combination is performed, for a set of subbands, using the set of beams for each set of subbands. The codeword can be based at least in part on the linear combination, and can indicate the set of beams and/or respective amplitudes, phase coefficients, and/or the like. Thus, the UE can provide an indication of channel state at the UE and can request the set of beams to be used for the UE. The type-II codebook can provide more precise specification of the channel state than a type-I codebook, which can provide a predefined codeword-based approach to specifying selected beams. Thus, the type-II codebook can be referred to as a high resolution codebook in comparison to the type-I codebook. The type-II codebook can improve MU-MIMO performance on the communication link.

A UE can communicate with a number of TRPs using beams. A TRP is a network node configured to transmit and receive signals. For example, a TRP can include one or more components of a base station. In some cases, a UE can communicate with multiple TRPs simultaneously (e.g., at the same time) in accordance with a mTRP configuration. In mTRP downlink communications, the UE can receive a number of communications, each from a different TRP.

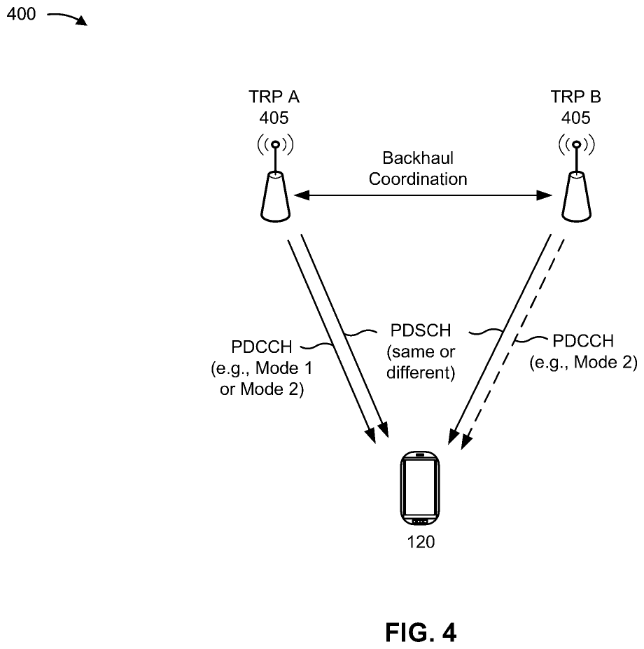

FIG. 4 is a diagram illustrating an example 400 of mTRP communication (sometimes referred to as multi-panel communication), in accordance with the present disclosure. As shown in FIG. 4, multiple TRPs 405 can communicate with the same UE 120. A network node can include multiple TRPs 405, or multiple TRPs 405 can be distributed across multiple network nodes.

The multiple TRPs 405 (shown as TRP A and TRP B) can communicate with the same UE 120 in a coordinated manner (e.g., using coordinated multipoint transmissions) to improve reliability and/or increase throughput. The TRPs 405 can coordinate such communications via an interface between the TRPs 405 (e.g., a backhaul interface and/or an access node controller). The interface can have a smaller delay and/or higher capacity when the TRPs 405 are co-located at the same network node (e.g., when the TRPs 405 are different antenna arrays or panels of the same network node), and can have a larger delay and/or lower capacity (as compared to co-location) when the TRPs 405 are located at different network nodes. The different TRPs 405 can communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) can be used to schedule downlink data communications for a single PDSCH. In this case, multiple TRPs 405 (e.g., TRP A and TRP B) can transmit communications to the UE 120 on the same PDSCH. For example, a communication can be transmitted using a single codeword with different spatial layers for different TRPs 405 (e.g., where one codeword maps to a first set of layers transmitted by a first TRP 405 and maps to a second set of layers transmitted by a second TRP 405). As another example, a communication can be transmitted using multiple codewords, where different codewords are transmitted by different TRPs 405 (e.g., using different sets of layers). In either case, different TRPs 405 can use different QCL relationships (e.g., different TCI states) for different DMRS ports corresponding to different layers. For example, a first TRP 405 can use a first QCL relationship or a first TCI state for a first set of DMRS ports corresponding to a first set of layers, and a second TRP 405 can use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) can indicate the first QCL relationship (e.g., by indicating a first TCI state) and the second QCL relationship (e.g., by indicating a second TCI state). The first and the second TCI states can be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs can be used to schedule downlink data communications for multiple corresponding PDSCHs (e.g., one PDCCH for each PDSCH). In this case, a first PDCCH can schedule a first codeword to be transmitted by a first TRP 405, and a second PDCCH can schedule a second codeword to be transmitted by a second TRP 405. Furthermore, first DCI (e.g., transmitted by the first TRP 405) can schedule a first PDSCH communication associated with a first set of DMRS ports with a first QCL relationship (e.g., indicated by a first TCI state) for the first TRP 405, and second DCI (e.g., transmitted by the second TRP 405) can schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) can indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

Each communication in an mTRP configuration can be a spatial layer of a joint communication associated with a PDSCH. A joint communication is a communication that includes more than one signal that shares one or more time resources. Each TRP can be disposed at a different location than each other TRP and, as a result, each respective communication can be associated with one or more different respective spatial resources. Thus, each respective communication can be a spatial layer of the joint communication. A spatial layer of a joint communication is a portion of the joint communication that corresponds to a set of spatial resources. For example, a joint communication can include a first spatial layer corresponding to a first set of spatial resources and a second spatial layer corresponding to a second set of spatial resources.

To receive a joint communication from the multiple TRPs, a single wide beam corresponding to a single TCI state can be used. However, the single wide beam can result in application of a single spatial filter that applies to all of the layers of the joint communication, which may not be coherent (e.g., the layers of the joint communication may not have respective phases such that the layers can be constructively combined at a receiving device). A spatial filter is a mechanism (e.g., a process, procedure, circuitry, and/or software, among other examples) used to direct an electromagnetic signal into a certain path. In some cases, a coherent joint transmission (CJT) configuration can be used for a coherent joint communication to facilitate more efficient application of spatial filters, which can result in fewer missed signals and more spectral efficiency.

Once a network node and a UE have selected beams for one or more beam pairs, the network node may be aware of one or more UE beams used by the UE. However, the UE may autonomously switch a receive beam (e.g., a UE beam of a beam pair) based at least in part on changed reception conditions. If the UE autonomously switches a receive beam (e.g., based at least in part on mobility of the UE, rotation of the UE, and/or the like), the network node may be unaware that the UE has switched receive beams until a subsequent CSF report and/or a subsequent beam report. Based at least in part on the network node being unaware that the UE has switched receive beams, the network node may use outdated CSI, which may degrade performance of a communication link between the network node and the UE. For example, based at least in part on the network node using outdated CSI, the UE may receive downlink communications with an increased error rate and/or with suboptimal spectral efficiency, among other examples, which may consume communication and network resources.

In some aspects described herein, a UE may determine a change of one or more reception conditions and may transmit (e.g., autonomously) a beam management request communication including a plurality of beam management requests, each of which corresponds to a TRP of a plurality of TRPS, for a beam management operation to update at least one beam associated with at least one TRP of a plurality of TRPs in communications with the UE. In some aspects, a change of one or more reception conditions may include, or may be based at least in part on, the UE changing a UE transmission beam and/or a UE reception beam, a link quality change (e.g., a change in RSRP, SINR, pathloss, and/or the like), movement of the UE, a speed change of the UE, an orientation change of the UE, detected reflector and/or scatter changes (e.g., angle and/or strength changes of received signals), and/or the like.

In some aspects, the UE may transmit the beam management request communication via one or more MAC CEs and/or via UCI. In some aspects, the UE may use an existing grant to transmit the beam management request communication, request a new grant to transmit the beam management request communication, and/or transmit the beam management request communication with other UCI (e.g., HARQ feedback).

Based at least in part on receiving the request for the radio link adaptation operation, the network node (which may be, include, or be included in, one or more TRPs of the plurality of TRPs) may schedule the UE to receive one or more reference signals and/or report measurements and/or metrics associated with the one or more reference signals. This may facilitate beam synchronization between the TRPs and UE and may allow the TRPs to receive current CSI to determine downlink transmission parameters. Based at least in part on the TRPs receiving current CSI to determine downlink transmission parameters, the TRPs (e.g., via the network node) may determine proper transmission parameters (e.g., an MCS, a transport block size, a resource allocation, a transmit power, a beam direction, and/or the like) for downlink communications, which may conserve communication, network, and/or power resources associated with the UE and/or the TRPs.

As indicated above, FIG. 4 is provided as an example. Other examples may differ from what is described with regard to FIG. 4.

FIG. 5 is a diagram illustrating an example 500 associated with UE initiated beam management requests associated with mTRPs, in accordance with the present disclosure. As shown in FIG. 5, a UE 502 and a network node 504 may communicate with one another. In some aspects, the UE 502 may be, be similar to, include, or be included in, the UE 120 depicted in FIGS. 1-4. In some aspects, the network node 504 may be, be similar to, include, or be included in, the network node 110 depicted in FIGS. 1, 2, and 4, and/or one or more components of the disaggregated base station architecture 300 depicted in FIG. 3. The network node 504 may be or include a plurality of TRPs.

As shown by reference number 506, the network node 504 may transmit, and the UE 502 may receive, configuration information. In some aspects, the configuration information may be carried in one or more RRC messages. The configuration information may be associated with reporting CSI associated with a plurality of TRPs. In some aspects, the configuration information may include at least one of an RSRP threshold or an SINR threshold for use in determining a change in reception conditions. In some aspects, one or more of the RSRP threshold and the SINR threshold may be specified in a wireless communication standard and, thus, maintained in a memory of the UE. In some aspects, the configuration information may indicate at least one CC and/or at least one CC group associated with a TCI, a CSI reporting configuration, and/or a beam management request, among other examples.

As shown by reference number 508, the network node 504 may transmit, and the UE 502 may receive, a first set of reference signals. As shown by reference number 510, the UE 502 may determine a change of one or more reception conditions. For example, in some aspects, the change may include an RSRP associated with a QCL reference signal corresponding to a TCI satisfying an RSRP threshold. In some aspects, the change may include an SINR, associated with the QCL reference signal corresponding to the TCI satisfying an SINR threshold.

As shown by reference number 512, the UE 502 may transmit, and the network node 504 may receive, a beam management request communication. In some aspects, the beam management request communication may include a plurality of beam management requests. Each beam management request of the plurality of beam management requests may correspond to a respective TRP of a plurality of TRPs. In some aspects, the beam management request communication may indicate a change of one or more reception conditions associated with one or more of the plurality of TRPs. In some aspects, the change of the one or more reception conditions may include at least one of an RSRP, associated with a QCL reference signal corresponding to a TCI, that satisfies an RSRP threshold, or an SINR, associated with the QCL reference signal corresponding to the TCI, that satisfies an SINR threshold.

In some aspects, the UE 502 may transmit the beam management request communication based on transmitting UCI including the plurality of beam management requests. In some aspects, the UCI includes a HARQ codebook, and the plurality of beam management requests may include a plurality of bits appended to the HARQ codebook. In some aspects, transmitting the beam management request communication may include transmitting the beam management request communication based on the UCI comprising the HARQ codebook. In some aspects, the plurality of beam management requests may correspond to at least one respective TCI, and transmitting the beam management request communication may include transmitting the beam management request communication based on the at least one TCI being applied to a physical downlink shared channel in the HARQ codebook.

In some aspects, the UCI may be scheduled to be multiplexed with additional UCI. For example, the additional UCI may include at least one of a HARQ codebook, a scheduling request, a CSI part 1 communication, or a CSI part 2 communication. A UCI priority associated with the beam management request communication may be equal to a priority associated with the HARQ codebook and a priority associated with the scheduling request. In some aspects, a UCI priority associated with the beam management request communication may be equal to a priority associated with the CSI part 1 communication, lower than a priority associated with the HARQ codebook, and lower than a priority associated with the scheduling request.

In some aspects, a UCI priority associated with the beam management request communication may be equal to a priority associated with the CSI part 2 communication and lower than a priority associated with the CSI part 1 communication. In some aspects, a UCI priority associated with the beam management request communication may be lower than a priority associated with the CSI part 2 communication. In some aspects, the UE 502 may transmit the beam management request communication based on transmitting a MAC CE including the plurality of beam management requests. In some aspects, a beam management request of the plurality of beam management requests may be associated with at least one of a respective CC or a respective CC group.

In some aspects, each beam management request of the plurality of beam management requests may include only one bit corresponding to the respective TRP. Each beam management request of the plurality of beam management requests may include a set of bits corresponding to the respective TRP, and a quantity of bits in the set of bits may be based on a bit quantity condition. In some aspects, each beam management request of the plurality of beam management requests may include a set of bits corresponding to the respective TRP, and the UE 502 may receive an indication of a quantity of bits in the set of bits.

As shown by reference number 514, the UE 502 and the network node 504 may perform a beam management operation. The beam management operation may be performed based on the beam management request communication. The UE 502 and the network node 504 may perform a beam management operation associated with at least one TRP of the plurality of TRPs.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 502) performs operations associated with UE initiated beam management requests associated with multiple TRPs.

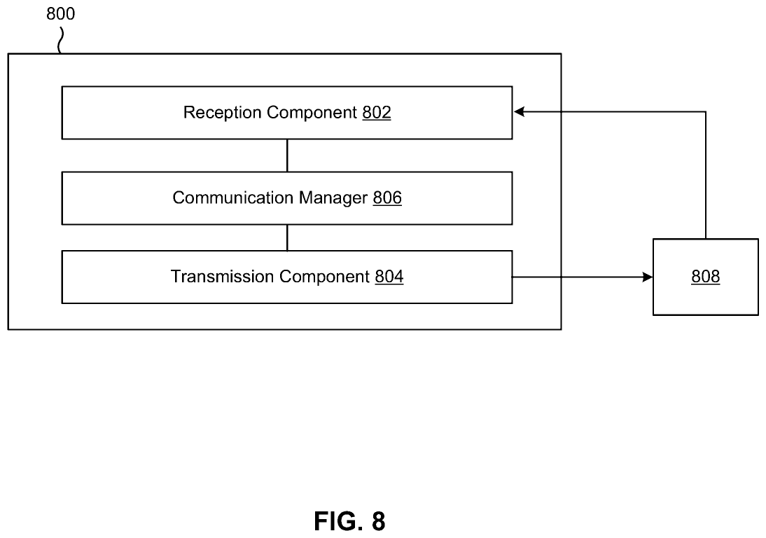

As shown in FIG. 6, in some aspects, process 600 may include transmitting a beam management request communication comprising a plurality of beam management requests, each beam management request of the plurality of beam management requests corresponding to a respective TRP of a plurality of TRPs (block 610). For example, the UE (e.g., using transmission component 804 and/or communication manager 806, depicted in FIG. 8) may transmit a beam management request communication comprising a plurality of beam management requests, each beam management request of the plurality of beam management requests corresponding to a respective TRP of a plurality of TRPs, as described above.

As further shown in FIG. 6, in some aspects, process 600 may include performing, based on the beam management request communication, a beam management operation associated with at least one TRP of the plurality of TRPs (block 620). For example, the UE (e.g., using communication manager 806, depicted in FIG. 8) may perform, based on the beam management request communication, a beam management operation associated with at least one TRP of the plurality of TRPs, as described above.

Process 600 may include additional aspects, such as any single aspect or any combination of aspects described below and/or in connection with one or more other processes described elsewhere herein.

In a first aspect, the beam management request communication indicates a change of one or more reception conditions associated with one or more of the plurality of TRPs. In a second aspect, alone or in combination with the first aspect, the change of the one or more reception conditions comprises at least one of an RSRP, associated with a QCL reference signal corresponding to a TCI, that satisfies an RSRP threshold, or an SINR, associated with the QCL reference signal corresponding to the TCI, that satisfies an SINR threshold. In a third aspect, alone or in combination with the second aspect, process 600 includes receiving an RRC message indicating at least one of the RSRP threshold or the SINR threshold. In a fourth aspect, alone or in combination with one or more of the second through third aspects, a memory of the UE includes an indication of at least one of the RSRP threshold or the SINR threshold.

In a fifth aspect, alone or in combination with one or more of the first through fourth aspects, transmitting the beam management request communication comprises transmitting UCI comprising the plurality of beam management requests. In a sixth aspect, alone or in combination with the fifth aspect, the UCI comprises a HARQ codebook, and wherein the plurality of beam management requests include a plurality of bits appended to the HARQ codebook. In a seventh aspect, alone or in combination with the sixth aspect, transmitting the beam management request communication comprises transmitting the beam management request communication based on the UCI comprising the HARQ codebook. In an eighth aspect, alone or in combination with one or more of the sixth through seventh aspects, the plurality of beam management requests correspond to at least one respective TCI, and wherein transmitting the beam management request communication comprises transmitting the beam management request communication based on the at least one TCI being applied to a physical downlink shared channel in the HARQ codebook.

In a ninth aspect, alone or in combination with one or more of the fifth through eighth aspects, the UCI is scheduled to be multiplexed with additional UCI. In a tenth aspect, alone or in combination with the ninth aspect, the additional UCI comprises at least one of a HARQ codebook, a scheduling request, a CSI part 1 communication, or a CSI part 2 communication. In an eleventh aspect, alone or in combination with the tenth aspect, a UCI priority associated with the beam management request communication is equal to a priority associated with the HARQ codebook and a priority associated with the scheduling request. In a twelfth aspect, alone or in combination with the tenth aspect, a UCI priority associated with the beam management request communication is equal to a priority associated with the CSI part 1 communication, lower than a priority associated with the HARQ codebook, and lower than a priority associated with the scheduling request. In a thirteenth aspect, alone or in combination with the tenth aspect, a UCI priority associated with the beam management request communication is equal to a priority associated with the CSI part 2 communication and lower than a priority associated with the CSI part 1 communication. In a fourteenth aspect, alone or in combination with the tenth aspect, a UCI priority associated with the beam management request communication is lower than a priority associated with the CSI part 2 communication.

In a fifteenth aspect, alone or in combination with one or more of the first through fourth aspects, transmitting the beam management request communication comprises transmitting a MAC control element (MAC CE) comprising the plurality of beam management requests. In a sixteenth aspect, alone or in combination with one or more of the first through fifteenth aspects, a beam management request of the plurality of beam management requests is associated with at least one of a respective CC or a respective CC group. In a seventeenth aspect, alone or in combination with the sixteenth aspect, process 600 includes receiving configuration information indicating the at least one of the respective CC or the respective CC group. In an eighteenth aspect, alone or in combination with one or more of the sixteenth through seventeenth aspects, the at least one of the respective CC or the respective CC group is associated with a TCI associated with the beam management request.

In a nineteenth aspect, alone or in combination with one or more of the first through eighteenth aspects, each beam management request of the plurality of beam management requests comprises only one bit corresponding to the respective TRP. In a twentieth aspect, alone or in combination with one or more of the first through eighteenth aspects, each beam management request of the plurality of beam management requests comprises a set of bits corresponding to the respective TRP, and wherein a quantity of bits in the set of bits is based on a bit quantity condition. In a twenty-first aspect, alone or in combination with one or more of the first through eighteenth aspects, each beam management request of the plurality of beam management requests comprises a set of bits corresponding to the respective TRP, the method further comprising receiving an indication of a quantity of bits in the set of bits.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 504) performs operations associated with UE initiated beam management requests associated with multiple TRPs.

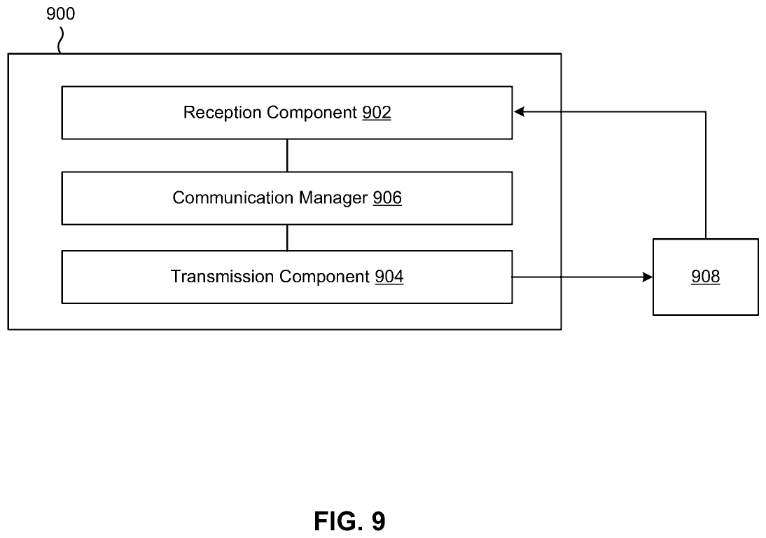

As shown in FIG. 7, in some aspects, process 700 may include receiving a beam management request communication comprising a plurality of beam management requests, each beam management request of the plurality of beam management requests corresponding to a respective TRP of a plurality of TRPs (block 710). For example, the network node (e.g., using reception component 902 and/or communication manager 906, depicted in FIG. 9) may receive a beam management request communication comprising a plurality of beam management requests, each beam management request of the plurality of beam management requests corresponding to a respective TRP of a plurality of TRPs, as described above.

As further shown in FIG. 7, in some aspects, process 700 may include performing, based on the beam management request communication, a beam management operation associated with at least one TRP of the plurality of TRPs (block 720). For example, the network node (e.g., using communication manager 906, depicted in FIG. 9) may perform, based on the beam management request communication, a beam management operation associated with at least one TRP of the plurality of TRPs, as described above.

Process 700 may include additional aspects, such as any single aspect or any combination of aspects described below and/or in connection with one or more other processes described elsewhere herein.

In a first aspect, the beam management request communication indicates a change of one or more reception conditions associated with one or more of the plurality of TRPs. In a second aspect, alone or in combination with the first aspect, the change of the one or more reception conditions comprises at least one of an RSRP, associated with a QCL reference signal corresponding to a TCI, that satisfies an RSRP threshold, or an SINR, associated with the QCL reference signal corresponding to the TCI, that satisfies an SINR threshold. In a third aspect, alone or in combination with the second aspect, process 700 includes transmitting an RRC message indicating at least one of the RSRP threshold or the SINR threshold. In a fourth aspect, alone or in combination with one or more of the first through third aspects, receiving the beam management request communication comprises receiving UCI comprising the plurality of beam management requests. In a fifth aspect, alone or in combination with the fourth aspect, the UCI comprises a HARQ codebook, and wherein the plurality of beam management requests include a plurality of bits appended to the HARQ codebook. In a sixth aspect, alone or in combination with the fifth aspect, receiving the beam management request communication comprises receiving the beam management request communication based on the UCI comprising the HARQ codebook.

In a seventh aspect, alone or in combination with one or more of the fifth through sixth aspects, the plurality of beam management requests correspond to at least one respective TCI, and wherein receiving the beam management request communication comprises receiving the beam management request communication based on the at least one TCI being applied to a physical downlink shared channel in the HARQ codebook. In an eighth aspect, alone or in combination with one or more of the first through seventh aspects, the UCI is scheduled to be multiplexed with additional UCI.

In a ninth aspect, alone or in combination with the eighth aspect, the additional UCI comprises at least one of a HARQ codebook, a scheduling request, a CSI part 1 communication, or a CSI part 2 communication. In a tenth aspect, alone or in combination with the ninth aspect, a UCI priority associated with the beam management request communication is equal to a priority associated with the HARQ codebook and a priority associated with the scheduling request. In an eleventh aspect, alone or in combination with the ninth aspect, a UCI priority associated with the beam management request communication is equal to a priority associated with the CSI part 1 communication, lower than a priority associated with the HARQ codebook, and lower than a priority associated with the scheduling request. In a twelfth aspect, alone or in combination with the ninth aspect, a UCI priority associated with the beam management request communication is equal to a priority associated with the CSI part 2 communication and lower than a priority associated with the CSI part 1 communication. In a thirteenth aspect, alone or in combination with the ninth aspect, a UCI priority associated with the beam management request communication is lower than a priority associated with the CSI part 2 communication.

In a fourteenth aspect, alone or in combination with one or more of the first through thirteenth aspects, receiving the beam management request communication comprises receiving a MAC CE comprising the plurality of beam management requests. In a fifteenth aspect, alone or in combination with one or more of the first through fourteenth aspects, a beam management request of the plurality of beam management requests is associated with at least one of a respective CC or a respective CC group. In a sixteenth aspect, alone or in combination with the fifteenth aspect, process 700 includes transmitting configuration information indicating the at least one of the respective CC or the respective CC group. In a seventeenth aspect, alone or in combination with one or more of the fifteenth through sixteenth aspects, the at least one of the respective CC or the respective CC group is associated with a TCI associated with the beam management request.

In an eighteenth aspect, alone or in combination with one or more of the first through seventeenth aspects, each beam management request of the plurality of beam management requests comprises only one bit corresponding to the respective TRP. In a nineteenth aspect, alone or in combination with one or more of the first through eighteenth aspects, each beam management request of the plurality of beam management requests comprises a set of bits corresponding to the respective TRP, and wherein a quantity of bits in the set of bits is based on a bit quantity condition. In a twentieth aspect, alone or in combination with one or more of the first through nineteenth aspects, each beam management request of the plurality of beam management requests comprises a set of bits corresponding to the respective TRP, the method further comprising receiving an indication of a quantity of bits in the set of bits.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit a beam management request communication comprising a plurality of beam management requests, each beam management request of the plurality of beam management requests corresponding to a respective TRP of a plurality of TRPs. The communication manager 806 may perform, based on the beam management request communication, a beam management operation associated with at least one TRP of the plurality of TRPs. The reception component 802 may receive an RRC message indicating at least one of the RSRP threshold or the SINR threshold. The reception component 802 may receive configuration information indicating the at least one of the respective CC or the respective CC group.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a beam management request communication comprising a plurality of beam management requests, each beam management request of the plurality of beam management requests corresponding to a respective TRP of a plurality of TRPs. The communication manager 906 may perform, based on the beam management request communication, a beam management operation associated with at least one TRP of the plurality of TRPs. The transmission component 904 may transmit an RRC message indicating at least one of the RSRP threshold or the SINR threshold. The transmission component 904 may transmit configuration information indicating the at least one of the respective CC or the respective CC group.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: transmitting a beam management request communication comprising a plurality of beam management requests, each beam management request of the plurality of beam management requests corresponding to a respective transmission reception point (TRP) of a plurality of TRPs; and performing, based on the beam management request communication, a beam management operation associated with at least one TRP of the plurality of TRPs.

Aspect 2: The method of Aspect 1, wherein the beam management request communication indicates a change of one or more reception conditions associated with one or more of the plurality of TRPs.

Aspect 3: The method of Aspect 2, wherein the change of the one or more reception conditions comprises at least one of: a reference signal received power (RSRP), associated with a quasi-co-location (QCL) reference signal corresponding to a transmission configuration indicator (TCI), that satisfies an RSRP threshold, or a signal to interference plus noise ratio (SINR), associated with the QCL reference signal corresponding to the TCI, that satisfies an SINR threshold.

Aspect 4: The method of Aspect 3, further comprising receiving a radio resource control (RRC) message indicating at least one of the RSRP threshold or the SINR threshold.

Aspect 5: The method of either of Aspects 3 or 4, wherein a memory of the UE includes an indication of at least one of the RSRP threshold or the SINR threshold.

Aspect 6: The method of any of Aspects 1-5, wherein transmitting the beam management request communication comprises transmitting uplink control information (UCI) comprising the plurality of beam management requests.

Aspect 7: The method of Aspect 6, wherein the UCI comprises a hybrid automatic repeat request (HARQ) codebook, and wherein the plurality of beam management requests include a plurality of bits appended to the HARQ codebook.

Aspect 8: The method of Aspect 7, wherein transmitting the beam management request communication comprises transmitting the beam management request communication based on the UCI comprising the HARQ codebook.

Aspect 9: The method of either of Aspects 7 or 8, wherein the plurality of beam management requests correspond to at least one respective transmission configuration indicator (TCI), and wherein transmitting the beam management request communication comprises transmitting the beam management request communication based on the at least one TCI being applied to a physical downlink shared channel in the HARQ codebook.

Aspect 10: The method of any of Aspects 6-9, wherein the UCI is scheduled to be multiplexed with additional UCI.

Aspect 11: The method of Aspect 10, wherein the additional UCI comprises at least one of a hybrid automatic repeat request (HARQ) codebook, a scheduling request, a channel state information (CSI) part 1 communication, or a CSI part 2 communication.

Aspect 12: The method of Aspect 11, wherein a UCI priority associated with the beam management request communication is equal to a priority associated with the HARQ codebook and a priority associated with the scheduling request.

Aspect 13: The method of Aspect 11, wherein a UCI priority associated with the beam management request communication is equal to a priority associated with the CSI part 1 communication, lower than a priority associated with the HARQ codebook, and lower than a priority associated with the scheduling request.

Aspect 14: The method of Aspect 11, wherein a UCI priority associated with the beam management request communication is equal to a priority associated with the CSI part 2 communication and lower than a priority associated with the CSI part 1 communication.

Aspect 15: The method of Aspect 11, wherein a UCI priority associated with the beam management request communication is lower than a priority associated with the CSI part 2 communication.

Aspect 16: The method of any of Aspects 1-5, wherein transmitting the beam management request communication comprises transmitting a medium access control (MAC) control element (MAC CE) comprising the plurality of beam management requests.

Aspect 17: The method of any of Aspects 1-16, wherein a beam management request of the plurality of beam management requests is associated with at least one of a respective component carrier (CC) or a respective CC group.

Aspect 18: The method of Aspect 17, further comprising receiving configuration information indicating the at least one of the respective CC or the respective CC group.

Aspect 19: The method of either of claims 17 or 18, wherein the at least one of the respective CC or the respective CC group is associated with a transmission configuration indicator (TCI) associated with the beam management request.

Aspect 20: The method of any of Aspects 1-19, wherein each beam management request of the plurality of beam management requests comprises only one bit corresponding to the respective TRP.

Aspect 21: The method of any of Aspects 1-19, wherein each beam management request of the plurality of beam management requests comprises a set of bits corresponding to the respective TRP, and wherein a quantity of bits in the set of bits is based on a bit quantity condition.

Aspect 22: The method of any of Aspects 1-19, wherein each beam management request of the plurality of beam management requests comprises a set of bits corresponding to the respective TRP, the method further comprising receiving an indication of a quantity of bits in the set of bits.

Aspect 23: A method of wireless communication performed by a network node, comprising: receiving a beam management request communication comprising a plurality of beam management requests, each beam management request of the plurality of beam management requests corresponding to a respective transmission reception point (TRP) of a plurality of TRPs; and performing, based on the beam management request communication, a beam management operation associated with at least one TRP of the plurality of TRPs.

Aspect 24: The method of Aspect 23, wherein the beam management request communication indicates a change of one or more reception conditions associated with one or more of the plurality of TRPs.

Aspect 25: The method of Aspect 24, wherein the change of the one or more reception conditions comprises at least one of: a reference signal received power (RSRP), associated with a quasi-co-location (QCL) reference signal corresponding to a transmission configuration indicator (TCI), that satisfies an RSRP threshold, or a signal to interference plus noise ratio (SINR), associated with the QCL reference signal corresponding to the TCI, that satisfies an SINR threshold.

Aspect 26: The method of Aspect 25, further comprising transmitting a radio resource control (RRC) message indicating at least one of the RSRP threshold or the SINR threshold.

Aspect 27: The method of any of Aspects 23-26, wherein receiving the beam management request communication comprises receiving uplink control information (UCI) comprising the plurality of beam management requests.

Aspect 28: The method of Aspect 27, wherein the UCI comprises a hybrid automatic repeat request (HARQ) codebook, and wherein the plurality of beam management requests include a plurality of bits appended to the HARQ codebook.

Aspect 29: The method of Aspect 28, wherein receiving the beam management request communication comprises receiving the beam management request communication based on the UCI comprising the HARQ codebook.

Aspect 30: The method of either of Aspects 28 or 29, wherein the plurality of beam management requests correspond to at least one respective transmission configuration indicator (TCI), and wherein receiving the beam management request communication comprises receiving the beam management request communication based on the at least one TCI being applied to a physical downlink shared channel in the HARQ codebook.

Aspect 31: The method of any of Aspects 27-30, wherein the UCI is scheduled to be multiplexed with additional UCI.

Aspect 32: The method of Aspect 31, wherein the additional UCI comprises at least one of a hybrid automatic repeat request (HARQ) codebook, a scheduling request, a channel state information (CSI) part 1 communication, or a CSI part 2 communication.

Aspect 33: The method of Aspect 32, wherein a UCI priority associated with the beam management request communication is equal to a priority associated with the HARQ codebook and a priority associated with the scheduling request.

Aspect 34: The method of Aspect 32, wherein a UCI priority associated with the beam management request communication is equal to a priority associated with the CSI part 1 communication, lower than a priority associated with the HARQ codebook, and lower than a priority associated with the scheduling request.

Aspect 35: The method of Aspect 32, wherein a UCI priority associated with the beam management request communication is equal to a priority associated with the CSI part 2 communication and lower than a priority associated with the CSI part 1 communication.

Aspect 36: The method of Aspect 32, wherein a UCI priority associated with the beam management request communication is lower than a priority associated with the CSI part 2 communication.

Aspect 37: The method of any of Aspects 23-26, wherein receiving the beam management request communication comprises receiving a medium access control (MAC) control element (MAC CE) comprising the plurality of beam management requests.

Aspect 38: The method of any of Aspects 23-37, wherein a beam management request of the plurality of beam management requests is associated with at least one of a respective component carrier (CC) or a respective CC group.

Aspect 39: The method of Aspect 38, further comprising transmitting configuration information indicating the at least one of the respective CC or the respective CC group.

Aspect 40: The method of either of claims 38 or 39, wherein the at least one of the respective CC or the respective CC group is associated with a transmission configuration indicator (TCI) associated with the beam management request.

Aspect 41: The method of any of Aspects 23-40, wherein each beam management request of the plurality of beam management requests comprises only one bit corresponding to the respective TRP.

Aspect 42: The method of any of Aspects 23-40, wherein each beam management request of the plurality of beam management requests comprises a set of bits corresponding to the respective TRP, and wherein a quantity of bits in the set of bits is based on a bit quantity condition.

Aspect 43: The method of any of Aspects 23-40, wherein each beam management request of the plurality of beam management requests comprises a set of bits corresponding to the respective TRP, the method further comprising receiving an indication of a quantity of bits in the set of bits.

Aspect 44: An apparatus for wireless communication at a device, comprising a processor; memory coupled with the processor; and instructions stored in the memory and executable by the processor to cause the apparatus to perform the method of one or more of Aspects 1-22.

Aspect 45: A device for wireless communication, comprising a memory and one or more processors coupled to the memory, the one or more processors configured to perform the method of one or more of Aspects 1-22.

Aspect 46: An apparatus for wireless communication, comprising at least one means for performing the method of one or more of Aspects 1-22.

Aspect 47: A non-transitory computer-readable medium storing code for wireless communication, the code comprising instructions executable by a processor to perform the method of one or more of Aspects 1-22.

Aspect 48: A non-transitory computer-readable medium storing a set of instructions for wireless communication, the set of instructions comprising one or more instructions that, when executed by one or more processors of a device, cause the device to perform the method of one or more of Aspects 1-22.

Aspect 49: An apparatus for wireless communication at a device, comprising a processor; memory coupled with the processor; and instructions stored in the memory and executable by the processor to cause the apparatus to perform the method of one or more of Aspects 23-43.

Aspect 50: A device for wireless communication, comprising a memory and one or more processors coupled to the memory, the one or more processors configured to perform the method of one or more of Aspects 23-43.

Aspect 51: An apparatus for wireless communication, comprising at least one means for performing the method of one or more of Aspects 23-43.

Aspect 52: A non-transitory computer-readable medium storing code for wireless communication, the code comprising instructions executable by a processor to perform the method of one or more of Aspects 23-43.

Aspect 53: A non-transitory computer-readable medium storing a set of instructions for wireless communication, the set of instructions comprising one or more instructions that, when executed by one or more processors of a device, cause the device to perform the method of one or more of Aspects 23-43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, that, based at least in part on information stored in the memory, are configured to:
transmit a beam management request communication comprising a plurality of beam management requests, each beam management request of the plurality of beam management requests corresponding to a respective transmission reception point (TRP) of a plurality of TRPs; and
perform, based on the beam management request communication, a beam management operation associated with at least one TRP of the plurality of TRPs.

2. The apparatus of claim 1, wherein the beam management request communication indicates a change of one or more reception conditions associated with one or more of the plurality of TRPs.

3. The apparatus of claim 2, wherein the change of the one or more reception conditions comprises at least one of:
a reference signal received power (RSRP), associated with a quasi-co-location (QCL) reference signal corresponding to a transmission configuration indicator (TCI), that satisfies an RSRP threshold, or
a signal to interference plus noise ratio (SINR), associated with the QCL reference signal corresponding to the TCI, that satisfies an SINR threshold.

4. The apparatus of claim 3, wherein the one or more processors are further configured to receive a radio resource control (RRC) message indicating at least one of the RSRP threshold or the SINR threshold.

5. The apparatus of claim 3, wherein a memory of the UE includes an indication of at least one of the RSRP threshold or the SINR threshold.

6. The apparatus of claim 1, wherein the one or more processors, to transmit the beam management request communication, are configured to transmit uplink control information (UCI) comprising the plurality of beam management requests.

7. The apparatus of claim 6, wherein the UCI comprises a hybrid automatic repeat request (HARQ) codebook, and wherein the plurality of beam management requests include a plurality of bits appended to the HARQ codebook.

8. The apparatus of claim 7, wherein the one or more processors, to transmit the beam management request communication, are configured to transmit the beam management request communication based on the UCI comprising the HARQ codebook.

9. The apparatus of claim 7, wherein the plurality of beam management requests correspond to at least one respective transmission configuration indicator (TCI), and wherein the one or more processors, to transmit the beam management request communication, are configured to transmit the beam management request communication based on the at least one TCI being applied to a physical downlink shared channel in the HARQ codebook.

10. The apparatus of claim 6, wherein the UCI is scheduled to be multiplexed with additional UCI.

11. The apparatus of claim 10, wherein the additional UCI comprises at least one of a hybrid automatic repeat request (HARQ) codebook, a scheduling request, a channel state information (CSI) part 1 communication, or a CSI part 2 communication.

12. The apparatus of claim 11, wherein a UCI priority associated with the beam management request communication is equal to a priority associated with the HARQ codebook and a priority associated with the scheduling request.

13. The apparatus of claim 11, wherein a UCI priority associated with the beam management request communication is equal to a priority associated with the CSI part 1 communication, lower than a priority associated with the HARQ codebook, and lower than a priority associated with the scheduling request.

14. The apparatus of claim 11, wherein a UCI priority associated with the beam management request communication is equal to a priority associated with the CSI part 2 communication and lower than a priority associated with the CSI part 1 communication.

15. The apparatus of claim 11, wherein a UCI priority associated with the beam management request communication is lower than a priority associated with the CSI part 2 communication.

16. The apparatus of claim 1, wherein the one or more processors, to transmit the beam management request communication, are configured to transmit a medium access control (MAC) control element (MAC CE) comprising the plurality of beam management requests.

17. The apparatus of claim 1, wherein a beam management request of the plurality of beam management requests is associated with at least one of a respective component carrier (CC) or a respective CC group.

18. The apparatus of claim 17, wherein the one or more processors are further configured to receive configuration information indicating the at least one of the respective CC or the respective CC group.

19. The apparatus of claim 17, wherein the at least one of the respective CC or the respective CC group is associated with a transmission configuration indicator (TCI) associated with the beam management request.

20-22. (canceled)

23. An apparatus for wireless communication at a network node, comprising:
a memory; and
one or more processors, coupled to the memory, that, based at least in part on information stored in the memory, are configured to:
receive a beam management request communication comprising a plurality of beam management requests, each beam management request of the plurality of beam management requests corresponding to a respective transmission reception point (TRP) of a plurality of TRPs; and
perform, based on the beam management request communication, a beam management operation associated with at least one TRP of the plurality of TRPs.

24-30. (canceled)
